(19) United States
(12) Patent Application Publication
(10) Pub. No.: US 2013/0080914 A1
(43) Pub. Date: Mar. 28, 2013

(54) STORAGE AND EXPOSURE OF UNIFIED CONTACTS BASED ON MATCH CRITERIA

(71) Applicants: Jeremy de Souza, Redmond, WA (US); Mayerber Carvalho Neto, Kirkland, WA (US); Komal Kashiramka, Redmond, WA (US); Ladislau Conceicao, Redmond, WA (US); Ross TenEyck, Seattle, WA (US)

(72) Inventors: Jeremy de Souza, Redmond, WA (US); Mayerber Carvalho Neto, Kirkland, WA (US); Komal Kashiramka, Redmond, WA (US); Ladislau Conceicao, Redmond, WA (US); Ross TenEyck, Seattle, WA (US)

(73) Assignee: Microsoft Corporation, Redmond, WA (US)

(21) Appl. No.: 13/246,865

(22) Filed: Sep. 28, 2011

(51) Int. Cl. G06F 3/01; G06F 15/16

(52) U.S. Cl. 715/752

(57) ABSTRACT

Individual contact information from a variety of sources are linked into a unified contact view to provide consistent user experience across platforms, while contact data is tracked in a distributed fashion. A communication application unifying multiple sources of contact data into a single logical view may communicate to a user that the unification has occurred. Through granular change tracking and data linkage, the user may be empowered to both understand and correct any system action. Match criteria for contact information may be exposed in individual contact views and in the unified contact view clarifying to the user matching and conflicting contact information.

### BACKGROUND

Contemporary communication systems enable users to have a number of identities over various systems such as enterprise emails, personal emails, social networking exchanges, and comparable ones. Each of these systems may generate contact lists based on automatic processing of exchange information and/or manual input. A structure and content of contact information for distinct communication systems may be different depending on their infrastructure. Thus, a user may have a plurality of contact information for the same contact stored in each communication system they are associated with.

Increasingly, other applications are becoming capable of providing access to multiple communication systems for a user. For example, an electronic mail exchange application may be configured to send and receive emails from a variety of systems for a user managing the user's identities automatically. Because each communication system tends to have its own contact lists, it is a challenge for users to manage multiple contacts while using multiple communication clients. Conflicts arise when a user attempts to communicate with a contact while accessing the contact information from multiple sources. Contact information conflict resolution systems can be black boxes that hide the resolution process from the user. Hidden resolution processes worsen user confidence in contact lists and contact information. Lack of user confidence removes any benefit provided through automating manual processes such as contact management.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to unifying multiple sources of contact data into a single logical view and communicating to a user via a variety of techniques that the unification has occurred. Through granular change tracking and data linkage, the user may be empowered to both understand and correct any system action. Match criteria for contact information may be exposed in individual contact views and in the unified contact view clarifying to the user matching and conflicting contact information.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 is a conceptual diagram illustrating a basic example of a system exposing match criteria for unified contact information;

FIG. 2 illustrates major components of an application unifying contact information from different sources while exposing the match criteria to clarify the consolidation process to a user;

FIG. 3 illustrates a diagram of high-level interactions between different layers of a system according to embodiments;

FIG. 4 illustrates two example user interfaces displaying available links and a suggested link along with match criteria in a process for generating a unified contact view;

FIG. 5 illustrates another example user interface an automatic link with detailed contact information and matching criteria;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of providing unified contact information while exposing match criteria according to embodiments.

### DETAILED DESCRIPTION

As briefly described above, multiple sources of contact data may be unified into a single logical view and communicated to a user via a variety of techniques that the unification has occurred. Through granular change tracking and data linkage, the user may be empowered to both understand and correct any system action. Match criteria for contact information may be exposed in individual contact views and in the unified contact view clarifying to the user matching and conflicting contact information. The external sources may include a social network application, a professional networking application, an email server, and similar ones.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a contact may be a consolidated set of data needed to communicate with another user. Contact information may include the user's name, email address(es), telephone number(s), user-id(s), address(es), etc. Contact information may also include dynamic information such as a user's presence information including availability and location. Contact information may be retrieved from external sources to supplement primary contacts. Retrieved contact information may be in conflict with a primary contact (displayed by a communication application) due to a variety of reasons. Retrieved contact information may match the primary contact by having common identifier information such as a user's whole name or partial name, user id, and email address. The matching contact information may have information not found in the primary contact.

Throughout this specification, the term “server” generally refers to a computing device executing one or more software programs typically in a networked environment. However, a server may also be implemented as a virtual server (software programs) executed on one or more computing devices viewed as a server on the network. Similarly, a “client” may refer to a computing device enabling access to a communication system or an application executed on a computing device enabling a user to access a networked system such as a social networking service, an email exchange service, and comparable ones. More detail on these technologies and example operations is provided below.

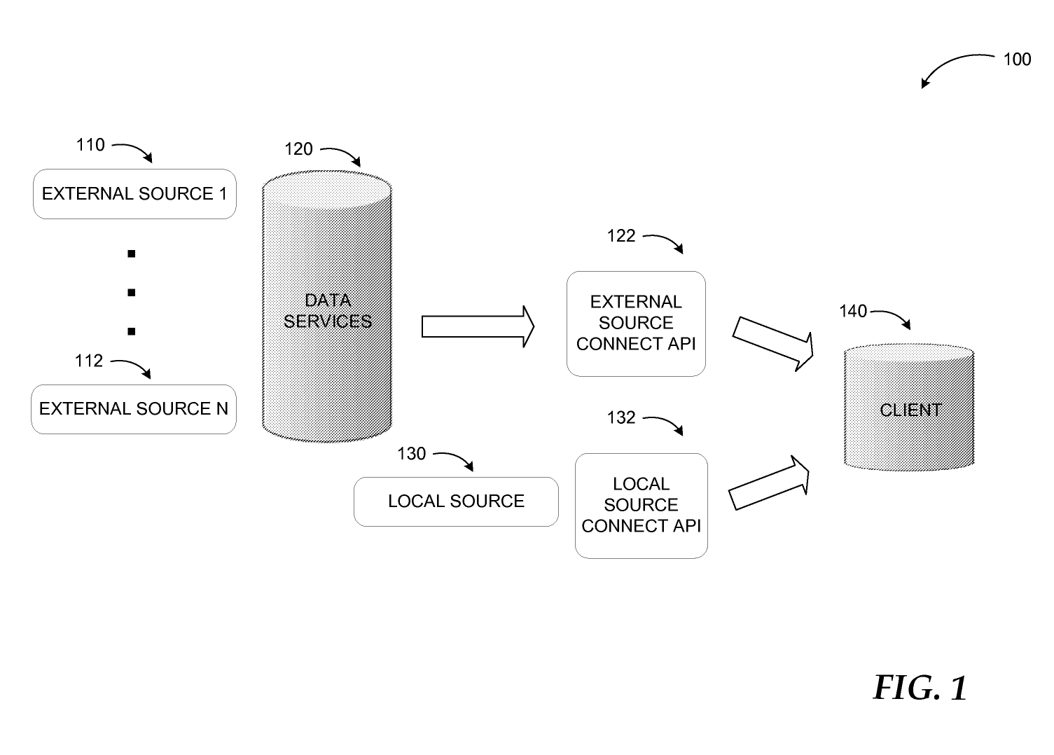

Referring to FIG. 1, diagram 100 illustrates a basic example of a system exposing match criteria for unified contact information. A communication application according to embodiments may retrieve contact information from a variety of sources and generate a unified contact view based on matching at least portions of the contact information from the different sources. In a typical scenario, a user may have a contact list in their communication application, which may be a local application or a hosted service. The contact list may include personal and professional contacts. The same user may also participate in social or professional networks, have other communication applications (e.g., an email application, a unified communication application, a text messaging application, and comparable ones). Thus, there may be contacts (or contact lists) associated with the user in each of those applications/services/networks.

A communication application may facilitate one or more communication modalities for client 140. The application may be a locally installed application or a hosted application accessed through a generic client application such as a browser. The communication application may maintain a contact list with contact information for a plurality of contacts at client 140. As part of contact management services, the communication application may receive contact information from a variety of external sources 110, 112, each of which may be associated their own data service or a combined data service 120. External sources 110, 112 may include, but are not limited to, social network services, professional network services, corporate directories, and similar ones. The communication application may also receive contact information from local sources 130 such as other communication applications installed on client 140.

The communication application may access the data services 120 through an external source connect application programming interface (API) 122. The application may utilize the external source connect API to negotiate with the data services 120 in order to retrieve contact information hosted by the external sources. In retrieving contact information from local sources 130, the communication application may employ local source API 132 in a similar manner to the external source connect API 122.

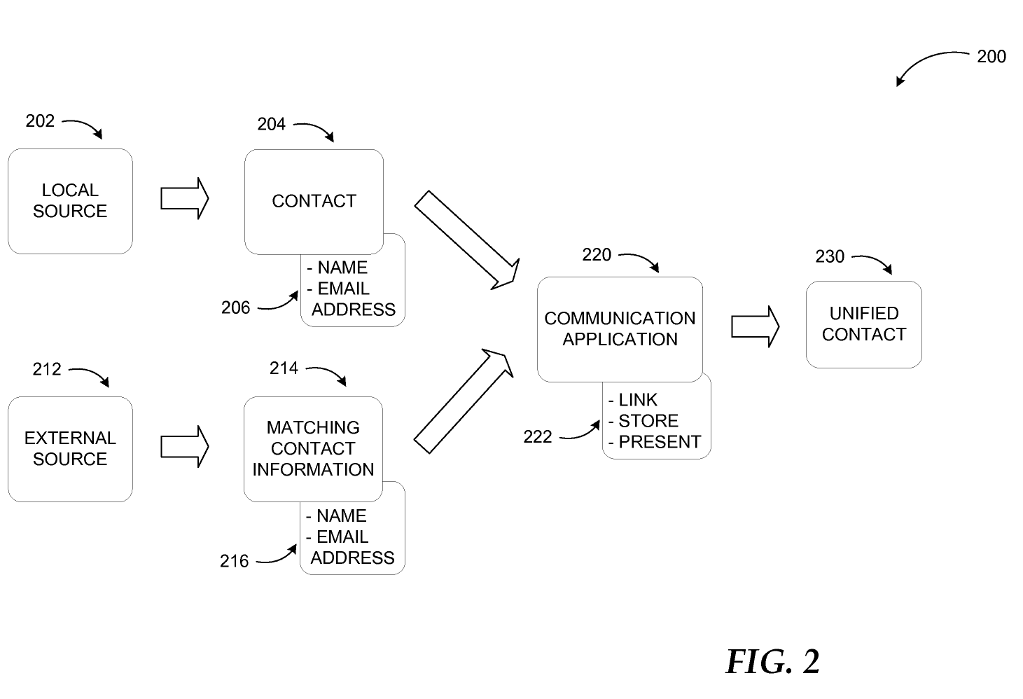

FIG. 2 illustrates in diagram 200 major components of an application unifying contact information from different sources while exposing the match criteria to clarify the consolidation process to a user. The communication application 220 may retrieve contact 204 from a local source 202. The contact 204 may have identifiers 206 such as name and email address. Additionally, the communication application 220 may also determine matching contact information 214 with identifiers 216 such as name, email address, phone numbers, presence information, etc. from external source 212 and link the contact information for a user. In a system according to embodiments, contact information that is linked together may be tracked in a distributed fashion. Thus, the information may be spread across all contacts in a person set (i.e., contacts that are linked together). The distributed tracking of contact information from different sources may employ network identifiers, service identifiers, and similar ones assigned to each data source to keep track of where contact information is originating from. Additionally, communication application 220 may track collateral information associated with each source such as images, icons, text strings, localization information, permissions, and so on. A system according to embodiments may employ an extensible model that allows efficient addition of new sources of information.

The communication application 220 may present along with the unified contact information about how each contact is linked (e.g., automatic, linked via suggestions, or manually linked by the user) and track the different types of linking on each contact in a distributed fashion. When a user manually links a contact, the contact, with which the user starts the operation, may be tracked dictating which information is to be selected as primary and reinforce to the user that they manually linked the other contacts to the primary one.

The match criteria for different types of linking may be highlighted in the unified contact (e.g., “automatic linking is by Name, Email address”). Furthermore, match criteria for suggested links (e.g., “same phone number”, “same email”, “same last name” may also be highlighted. According to some embodiments, the match criteria may be presented upon hover allowing the user to discover why a contact was linked without cluttering the user interface.

A system according to embodiments may also provide a scaled scope of attribution (contact level down to field level attribution) to assist a user to decide which information can be trusted and which information cannot be trusted. For example, the source for each suggested contact or field within a contact may be displayed. The unified contact may be presented employing a source independent architecture. Moreover, a summary merged view and component oriented views (just the data from a specific source) may be supported. The support for these different views may enable a user to understand which data sources and which specific data contribute to the unified contact view. The approach may also make it easier to the user to identify which data does not belong to the unified contact, understand which fields are read-only, editable, annotatable, etc.

A system according to some embodiments may automatically create a contact to store user annotations from a read-only contact. User annotations may be persisted in the user's mailbox, for example, and be presented in a primary contact list for an email application. Data from multiple sources may be disambiguated and a user may be presented with information indicating that redundant data is being shown but it is actually from multiple sources.

According to other embodiments, select fields within the contact information may be given weight over others and displayed (or displayed with higher priority). For example, a photo, a name, and a job title of a contact may be displayed in a primary user interface, which may be customized or drilled down by the user. Field level versioning and/or change tracking may be used to distinguish user updates to data versus system updates to data. For example, a phone number that is added by a user may be distinguished from another phone number for the same contact that came from a corporate directory. The unified contact view may also be customized based on a platform. For example, the amount of detailed information on matching criteria, sources, and others listed above may be scaled based on available bandwidth, screen size, processing power, etc. (e.g., wirelessly connected handheld mobile devices vs. desktop devices with wired connection).

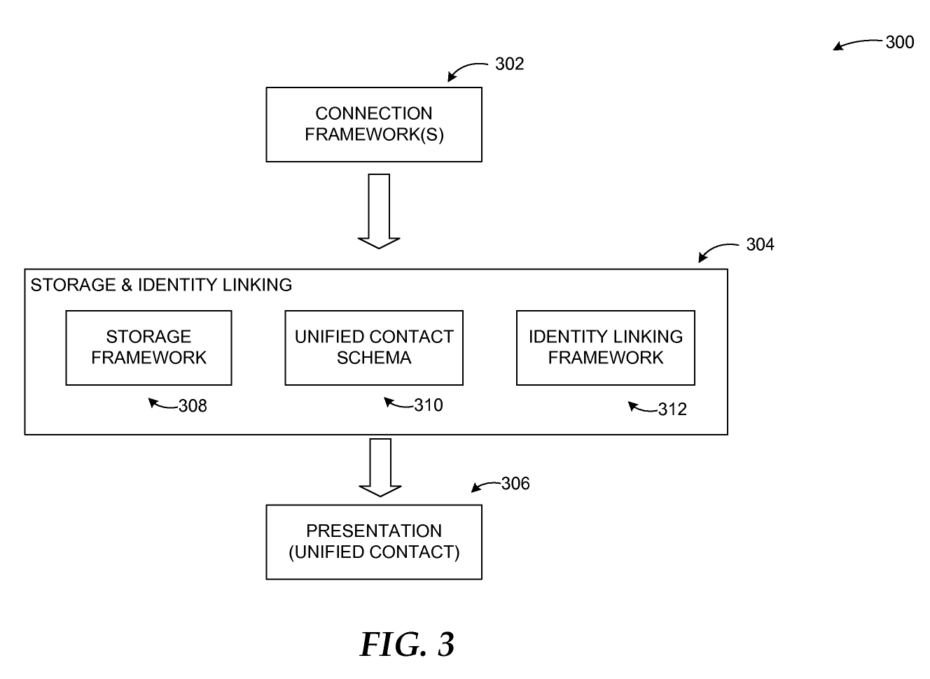

FIG. 3 illustrates a diagram 300 of high-level interactions between different layers of a system according to embodiments. During the initial communication application connection and subsequent processing of external updates to contact information, contact objects may be created or updated and links automatically created between identities to form people. These actions may be overseen by connection framework(s) 302.

The storage and identity linking layer 304 may enable a connection component to store contacts in appropriate location(s) based on the contact data provider (communication applications, hosted services, social networks, etc.) by a storage framework 308, create contacts according to a defined unified schema 310 that is understood by the communication application, and link contacts/identities to a specific person through an identity/linking framework 312. Thus, the identity/linking framework 312 may identify which contacts match existing contact objects and store the links.

The unified contact information may be presented (306) to user in a variety of ways. For example, all contacts, user's personal contacts, or aggregated contacts may be made available depending on an application type or platform used by the user. If a user composes a message, then the person instance shown in the recipient field may reflect that the recipient contact has multiple email addresses and allow the user to choose which email to use.

While the example communication applications, services, and platforms discussed in FIG. 1-3 may be an email service, embodiments may not be limited to an email service. Embodiments may be implemented in any application that facilitates real time or asynchronous communications such as Voice over Internet Protocol (VOIP) telephony, text messaging, video conferencing, application sharing, and comparable ones using the principles described herein.

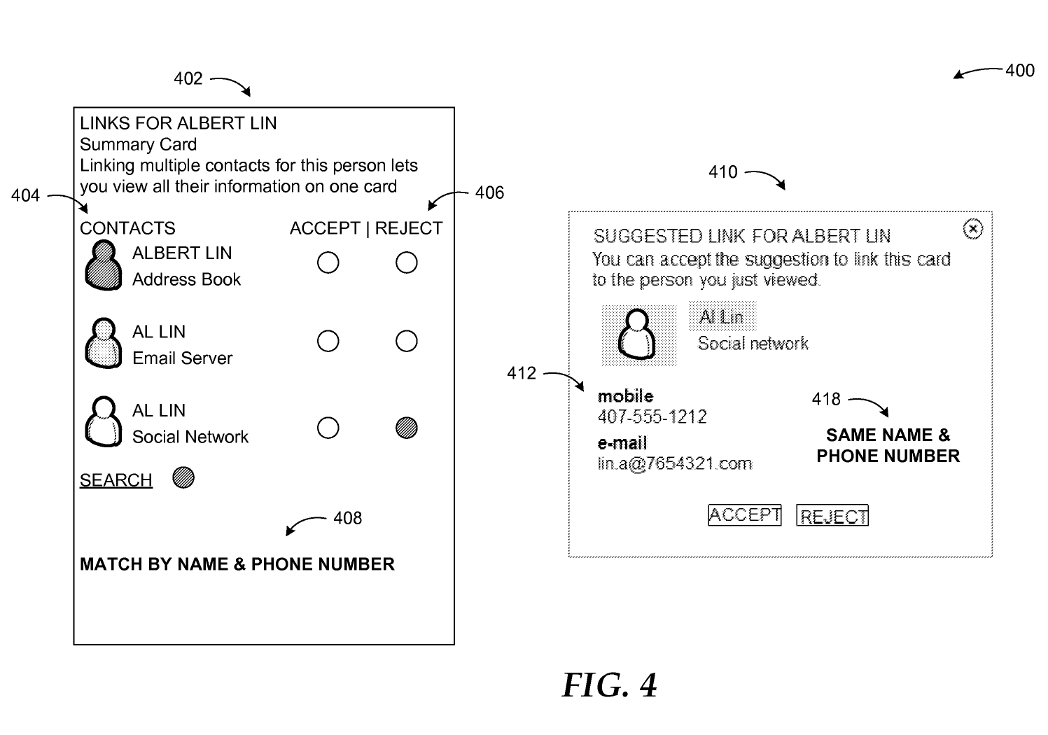

FIG. 4 illustrates two example user interfaces displaying available links and a suggested link along with match criteria in a process for generating a unified contact view in diagram 400. The first example user interface is a summary card 402 for contact “Albert Lin” presenting available contact information 404 for the contact from different sources such as address book, email server, and social network. The presented links include their respective sources such that a user can select whether to accept or reject (406) one or more of the links for a unified contact. The availability of the source information may provide user confidence for one or more of the links over the others. Example summary card 402 further presents match criteria 408 (e.g., “Match by name and phone number”) also enabling the user to decide whether the match criteria provides confidence for the found links. According to some embodiments, the user may be enabled to customize the match criteria and be presented additional, fewer, or a different set of links.

The second example user interface 410 presents a suggested link for contact Albert Lin. As mentioned previously, links may be created automatically, through suggestion, or manually by a user. The suggested link in the second user interface 410 may be generated by the system employing a matching algorithm or similar confidence based mechanism. The contact's source, phone number, email address, etc. (412) are displayed allowing the user to determine whether the information is the desired information. To further provide confidence in selecting or rejecting the suggested link, match criteria 418 is presented at the field level in this example (same phone number and email address). The user is also given the opportunity to accept or reject the suggested link.

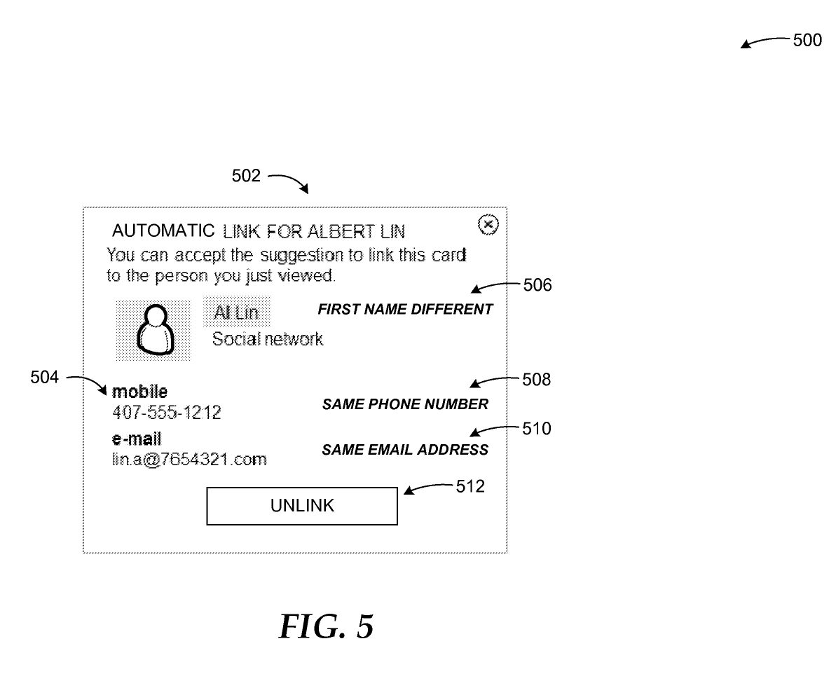

FIG. 5 illustrates another example user interface an automatic link with detailed contact information and matching criteria. Diagram 500 includes example user interface 502 presenting an automatically created link for a contact.

The automatically created link includes name, photo, and source of the contact information, as well as phone number and email address 504. Matching information is presented at field level granularity such as first name being different (506), phone number being the same (508), and email address being the same (510). This information enables the user to determine if this link is the one to be used for the unified contact. If the user decides not to keep the automatically created link, they are given the option to unlink (512) the presented contact information.

According to embodiments, each contact information source (e.g.: external and local) may have network or service identifier associated with the source. The identifier may be used by the communication application to identify the contact information source to the user.

In an embodiment, the communication application may display a history of unified matching contact information. The application may enable a user to select the contact information to display matching criteria. Matching contact information may be resolved through an automated process. As such, application policy may not allow the user to edit the matching contact information. The match criteria such as source type, identifiers such as name and address may be displayed. Although, the application may not allow the user to edit automatically unified matching contact information, the application may allow such read-only matching contact information to be annotated. The application may store annotation information in a primary contact. An example may be the application providing an annotation component in the linking user interface for the primary contact. Additionally, the annotations may persist through a variety of use scenarios including email applications.

The above discussed linking user interfaces and configurations in FIG. 4-5 are for illustration purposes. Embodiments are not restricted to those examples. Other forms of match criteria exposure may be used in the linking user interface in a similar manner using the principles described herein.

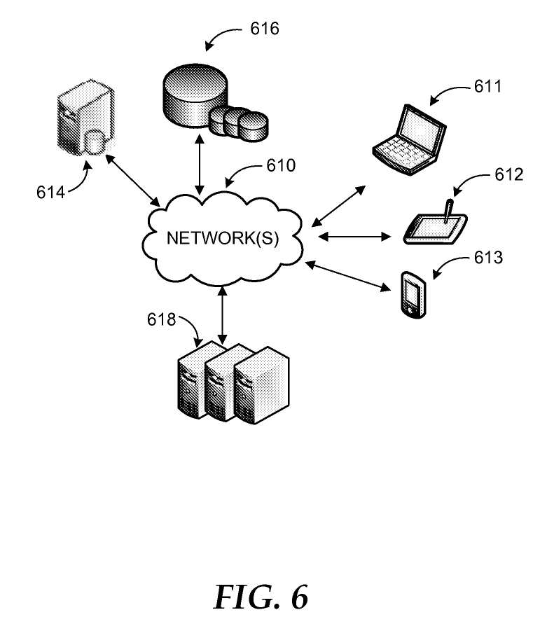

FIG. 6 is an example networked environment, where embodiments may be implemented. A communication application exposing match criteria for contact information unification may be implemented via software executed over one or more servers 618 such as a hosted service. The application may facilitate communications between client applications on individual computing devices such as a smart phone 613, a tablet computer 612, laptop computer 611, and a desktop computer (‘client devices’) through network(s) 610.

As discussed, match criteria may be exposed in a unified contact view to provide a user with information for confidence in selecting or rejecting available links (suggested or automatically created). Match criteria, match status, and similar information may be presented at contact level or field level.

Client devices 611-613 are used to facilitate communications through a variety of modes between users of the communication application. One or more of the servers 618 may be used to manage contact information as discussed above. Contact information may be stored in one or more data stores (e.g. data store 616), which may be managed by any one of the servers 618 or by database server 614.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, data sources, and data distribution systems may be employed to expose match criteria for contact information unification. Furthermore, the networked environments discussed in FIG. 6 are for illustration purposes only. Embodiments are not limited to the example applications, modules, or processes.

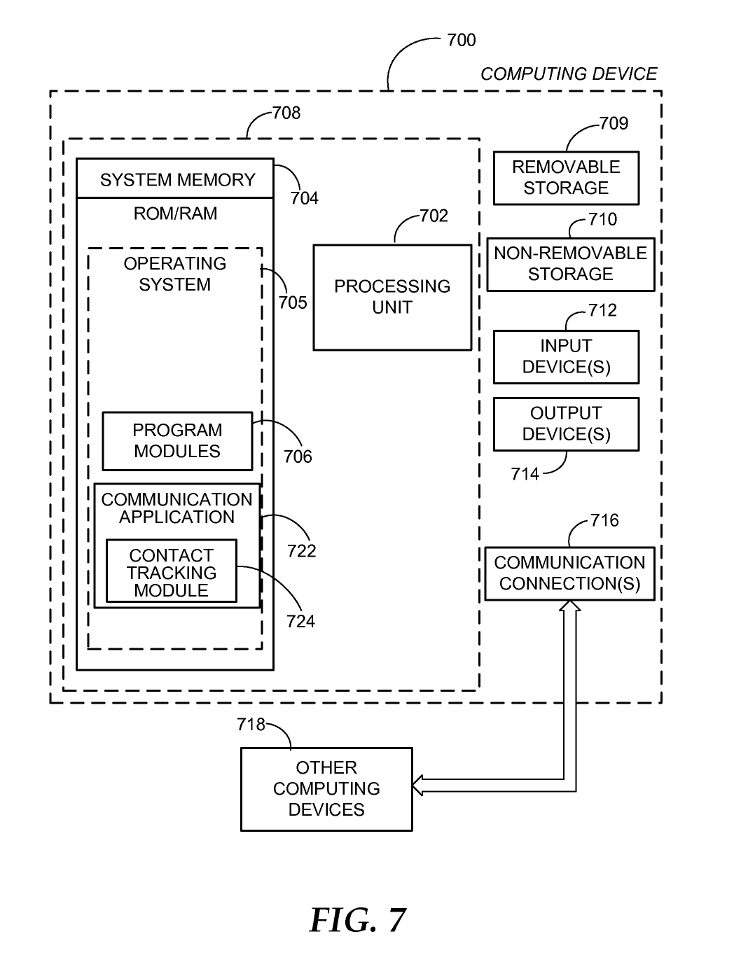

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be a match criteria exposure device as part of a communication system and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS®, operating systems from MICROSOFT CORPORATION of Redmond, Wash. The system memory 704 may also include one or more software applications such as program modules 706, communication application 722, and contact tracking module 724.

Communication application 722 may be part of a service that exposes match criteria for contact information unification for a variety of conflict resolutions including automated, suggestive, and manual. Contact tracking module 724 may present a consistent user experience across multiple platforms to increase user confidence in the contact unification process. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications, other directory or policy servers, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

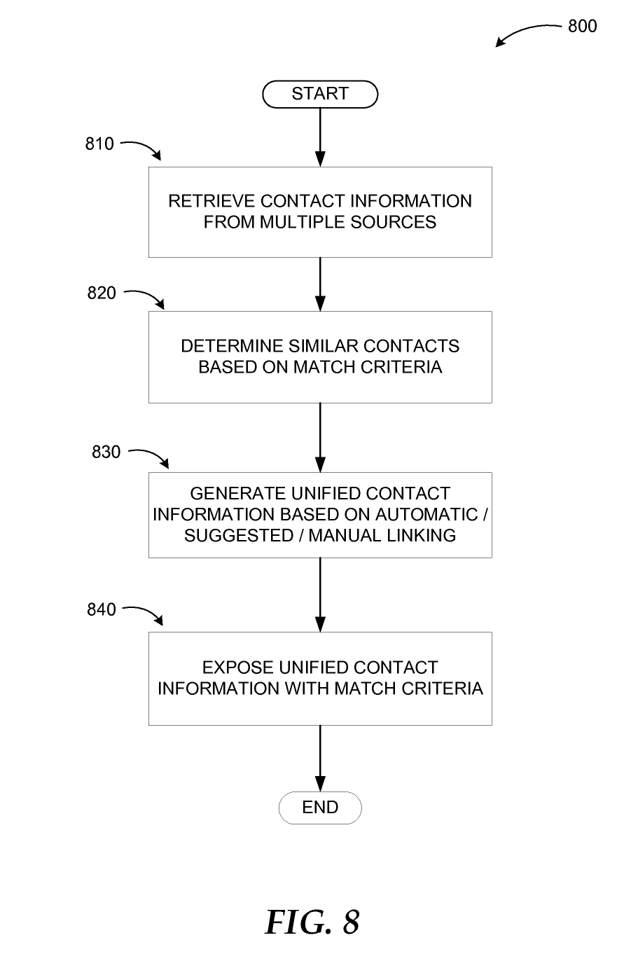

FIG. 8 illustrates a logic flow diagram for process 800 of providing unified contact information while exposing match criteria according to embodiments. Process 800 may be implemented as part of a communication application that exposes match criteria through a linking user interface.

Process 800 begins with operation 810, where the communication application may retrieve contact information from multiple sources. The sources may be local sources such as an address book or an external source such as a social network application, an email server, etc. Next, the application may determine similar contacts by matching contact information according to match criteria at operation 820. The match criteria may be similarity of individual or multiple field contents. The criteria may also be a weighted one prioritizing some fields (e.g., name, phone number) over others (e.g., birth date, city). The sources for matched contacts may be identified based on an identifier such that contact information can be tracked across different sources.

The application may generate unified contact information based on automatic creation, suggested linking, or manual linking by a user at operation 830. The application may expose the unified contact information along with the match criteria at operation 840 to provide confidence to the user in selecting or rejecting automatically linked or suggested contacts.

The operations included in process 800 are for illustration purposes. A communication application configured to expose match criteria for contact information unification according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for storing and exposing match criteria and unified contacts, the method comprising:
retrieving contact information from a plurality of sources;
determining similar contacts based on predefined match criteria;
generating at least one form a set of: an automatically created link and a suggested link among the similar contacts;
exposing the generated links and the predefined match criteria to a user; and
generating a unified contact based on at least one from a set of user acceptance and rejection of the generated links, wherein the contact information in the unified contact is distributed across contacts from the plurality of sources.

2. The method of claim 1, wherein the plurality of sources include one or more of: a social networking application, a professional networking application, an email service, and an address book.

3. The method of claim 1, further comprising:
retrieving at least one of the contacts from a local source including a local address book.

4. The method of claim 1, further comprising:
identifying a source contact information according to a network/service identifier assigned to the source.

5. The method of claim 1, wherein the contact information includes at least one from a set of: images, icons, text strings, localization information, and permissions.

6. The method of claim 1, further comprising:
enabling a user to manually provide contact information for a contact; and
including the manually provided contact in generation of the unified contact.

7. The method of claim 1, wherein the match criteria is exposed at one of a contact level and a field level.

8. The method of claim 1, further comprising:
presenting match status of a field for a contact in a unified contact view.

9. The method of claim 1, further comprising:
exposing the match criteria in response to a hover action by a user.

10. The method of claim 1, further comprising:
displaying a source associated with one of a contact and a field for a contact in a unified contact view.

11. The method of claim 10, wherein the unified contact view is organized based on a source-independent architecture.

12. A communication server for storing and exposing match criteria and unified contacts, the server comprising:
a memory;
a processor coupled to the memory, the processor executing a communication application, wherein the communication application is configured to:
retrieve contact information from a plurality of sources;
determine similar contacts based on predefined match criteria;
generate at least one form a set of: an automatically created link and a suggested link among the similar contacts;
expose the generated links and the predefined match criteria to a user;
generate a unified contact based on at least one from a set of user acceptance and rejection of the generated links, wherein the contact information in the unified contact is distributed across contacts from the plurality of sources; and
display a unified contact view that includes a source associated with one of a contact and a field for a contact.

13. The server of claim 12, wherein the communication application is further configured to:
scale a scope of attribution between a contact level and a field level to provide confidence to a user regarding presented contact information.

14. The server of claim 12, wherein the unified contact view includes one of: a summary merged view and a component-oriented view.

15. The server of claim 12, wherein the communication application is further configured to:
enable a user to customize the match criteria.

16. The server of claim 12, wherein the unified contact view includes summary of at least one of unlinked and rejected contacts to enable the user to undo accidental rejections.

17. The server of claim 12, wherein the communication application is further configured to:
automatically create a new a contact to store user annotations from a read-only contact;
persist the user annotations in a primary contact list; and
scale an amount of detailed information for matching criteria and sources displayed on the unified contact view based on one or more of: an available bandwidth, a screen size, and a processing power.

18. A computer-readable memory device with instructions stored thereon for exposing match criteria of contact information conflict resolution, the instructions containing:
retrieving contact information from a plurality of sources;
determining similar contacts based on predefined match criteria;
generating at least one form a set of: an automatically created link and a suggested link among the similar contacts;
enabling a user to manually provide contact information for a contact;
exposing the generated links and the predefined match criteria to a user;
generating a unified contact based on at least one from a set of user acceptance and rejection of the generated links, wherein the contact information in the unified contact is distributed across contacts from the plurality of sources;
including the manually provided contact in generation of the unified contact; and
displaying a unified contact view that includes a source associated with one of a contact and a field for a contact.

19. The computer-readable memory device of claim 18, wherein the instructions further comprise:
disambiguating the contact information from the plurality of sources for displaying in the unified contact view.

20. The computer-readable memory device of claim 18, wherein the instructions further comprise:
employing at least one from a set of: field level versioning and change tracking to distinguish user updates to the contact information and system updates to the contact information.
